(19) United States
(12) Patent Application Publication
(10) Pub. No.: US 2019/0275840 A1
(43) Pub. Date: Sep. 12, 2019

(54) HEAVY LOAD TIRE

(71) Applicant: BRIDGESTONE CORPORATION, Tokyo (JP)

(72) Inventor: Tomoo HASEGAWA, Tachikawa-shi (JP)

(73) Assignee: BRIDGESTONE CORPORATION, Tokyo (JP)

(21) Appl. No.: 16/303,651

(22) PCT Filed: May 26, 2017
(86) PCT No.: PCT/JP2017/019798

§ 371 Date: Nov. 20, 2018

(30) Foreign Application Priority Data
May 27, 2016 (JP) 2016-106225

(51) Int. Cl. B60C 9/20; B60C 11/03

(52) U.S. Cl. CPC B60C 9/20; B60C 11/0302; B60C 2009/2016; B60C 2200/06; B60C 2011/0372; B60C 2011/0367; B60C 2009/2019

(57) ABSTRACT

A heavy load tire includes a first inner widthwise groove which opens to a circumferential groove, and a first outer widthwise groove which extends outward in the tire-widthwise direction and opens to the circumferential groove at a location facing the first inner widthwise groove are arranged in the tire-circumferential direction on at least one side of the tire equator line of the tread portion. The first inner widthwise groove has an inflection point where a direction of a convex or a concave with respect to the tire-circumferential direction changes, and has a curved convex shape toward a tire normal rotation direction side from the inflection point to the circumferential groove. A groove wall forming the first outer widthwise groove on a side opposite to a tire normal rotation direction extends outward in the tire-widthwise direction while being inclined toward a side opposite to the tire normal rotation direction.

### TECHNICAL FIELD

The present invention relates to a heavy load tire provided with a tread portion.

### RELATED ART

A heavy load tire such as a construction vehicle tire is generally provided with a carcass ply, a belt layer, and a tread portion in order. In addition, the belt layer is usually composed of a plurality of belts, and Patent Literature 1 discloses a heavy load tire having: a protective belt layer composed of two protective belts, that is, a protective crossing belt layer; a main crossing belt layer composed of two main crossing belts; and a small crossing belt layer composed of two small crossing belts.

In such a tire, the main crossing belt layer is arranged on an outer side in a tire radial direction than the small crossing belt layer, and the protective belt layer is arranged on an outer side in the tire radial direction than the main crossing belt layer.

The angle formed by a tire circumferential direction and a cord constituting the small crossing belt layer is, for example, 4 to 10°, the angle formed by the tire circumferential direction and a cord constituting the main crossing belt layer is, for example, 18 to 35°, and the angle formed by the tire circumferential direction and a cord constituting the protective belt layer is, for example, 22 to 33°.

### CITATION LIST

### Patent Literature

### Patent Literature 1: WO 2013/157544

### SUMMARY OF INVENTION

### Technical Problem

When arranging a high angle belt having a small angle such as 4 to 10° between a belt cord and the tire circumferential direction, growth of a tire part due to the internal pressure or running, that is, increase in the tire diameter is suppressed.

As a result, increase in the tire diameter due to the internal pressure or running occurs at an outer part in a tire widthwise direction of the high angle belt, especially at a ¼ point which is a position spaced from the tire equator line by ¼ of the width in the tire widthwise direction of the tread portion. In addition, forces in opposite directions with respect to the tire rotational direction are generated at a tire part where the tire diameter is increased and at a tire part where the tire diameter is hardly increased, and a difference in the degree of deformation between both the tire parts generates shearing force, which is likely to cause uneven wear.

It is to be noted that such a phenomenon is not limited to a case where a high angle belt is arranged in the belt layer but also occurs in a case where the rolling radius is comparatively different in the same tire.

In addition, these are remarkable especially in large construction vehicle tires among heavy load tires.

The present invention has been made in view of the above-described problems, and it is an object of the present invention to provide a heavy load tire capable of improving uneven wear resistance property by suppressing shearing force to be generated between a tread rubber part where driving force is generated and a tread rubber part adjacent to the above-described tread rubber part where braking force is generated.

### Solution to Problem

A heavy load tire comprising according to first aspect of the present invention includes a tread portion. The tread portion is partitioned into a plurality of portions by a widthwise groove extending in a tire widthwise direction, and at least one of a circumferential groove extending in a tire circumferential direction and a tread end that is an end portion of the tread portion. The circumferential groove and the widthwise groove are formed on at least one side of a tire equator line. The widthwise groove is composed of a first inner widthwise groove, which opens to the circumferential groove, extends inward in the tire widthwise direction, and reaches the tire equator line, and a first outer widthwise groove, which is wider than the first inner widthwise groove, opens to the circumferential groove at a position opposed to the first inner widthwise groove, and extends outward in the tire widthwise direction, and are arrayed in the tire circumferential direction. The first inner widthwise groove has an inflection point where a direction of a convex or a concave with respect to the tire circumferential direction changes, extends from the inflection point to the tire equator line with an angle against the tire widthwise direction becoming smaller toward the tire equator line, and has a curved convex shape toward a tire normal rotation direction side from the inflection point to the circumferential groove. A groove wall forming the first outer widthwise groove on a side opposite to a tire normal rotation direction extends outward in the tire widthwise direction while being inclined toward a side opposite to the tire normal rotation direction.

A heavy load tire according to second aspect of the present invention includes a tread portion. The tread portion is partitioned into a plurality of portions by a widthwise groove extending in a tire widthwise direction, and at least one of a circumferential groove extending in a tire circumferential direction and a tread end that is an end portion of the tread portion. The circumferential groove and the widthwise groove are formed on at least one side of a tire equator line. The widthwise groove is composed of a first inner widthwise groove, which opens to the circumferential groove, extends inward in the tire widthwise direction, and reaches the tire equator line, and a first outer widthwise groove, which is wider than the first inner widthwise groove, opens to the circumferential groove at a position opposed to the first inner widthwise groove, and extends outward in the tire widthwise direction, and are arrayed in the tire circumferential direction. The first inner widthwise groove has an inflection point where a direction of a convex or a concave with respect to the tire circumferential direction changes, extends from the inflection point to the tire equator line with an angle against the tire widthwise direction becoming smaller toward the tire equator line, and has a curved convex shape toward a side opposite to the tire normal rotation direction from the inflection point to the circumferential groove. A groove wall forming the first outer widthwise groove on a side opposite to the tire normal rotation direction extends outward in the tire widthwise direction while being inclined toward the tire normal rotation direction side.

### Advantageous Effects of Invention

A heavy load tire according to the aspects of the present invention improves uneven wear resistance property by suppressing shearing force to be generated between a tread rubber part where driving force is generated and a tread rubber part adjacent to the above-described tread rubber part where braking force is generated.

### BRIEF DESCRIPTION OF DRAWINGS

FIG. 1 is a sectional view of a construction vehicle tire according to the first embodiment in a tire widthwise direction along a tire radial direction.

FIG. 2 is an explanatory drawing for explaining the belt structure of the construction vehicle tire according to the first embodiment.

FIG. 3 is a plan view for explaining a tread pattern in the construction vehicle tire according to the first embodiment.

FIG. 4 is a sectional view of a first inner widthwise groove formed at a tread portion of the construction vehicle tire according to the first embodiment.

FIG. 5 is a plan view for explaining a tread pattern in a construction vehicle tire according to the second embodiment.

### DESCRIPTION OF EMBODIMENTS

The following description will explain some embodiments of the present invention with reference to the attached drawings using a construction vehicle tire as an example of a heavy load tire. In the following description, the same or similar parts are denoted by the same or similar reference numerals, and detailed description thereof is appropriately omitted. Moreover, the following embodiments are illustrations for embodying the technical idea of the present invention, and embodiments of the present invention can be implemented with various modifications without departing from the gist.

### First Embodiment

First, the first embodiment will be described.

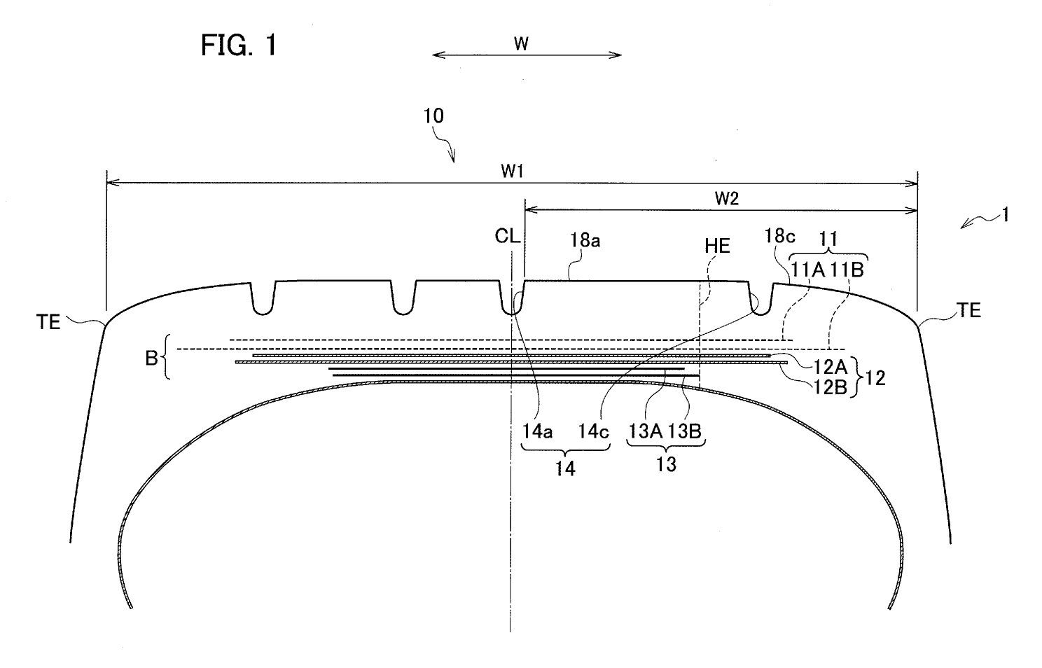

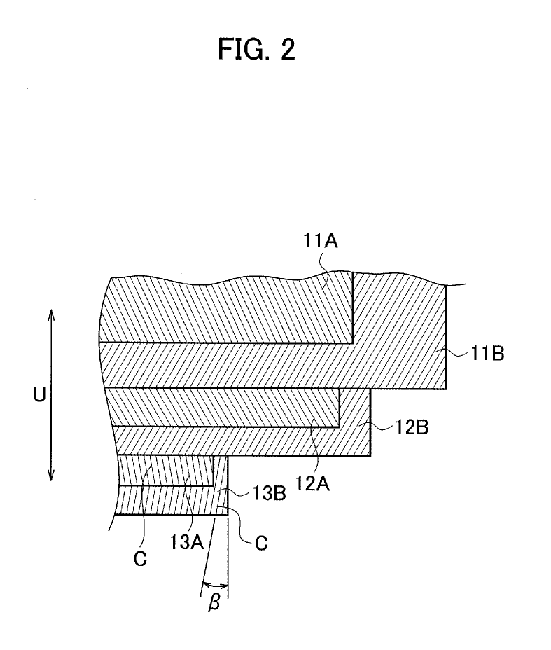

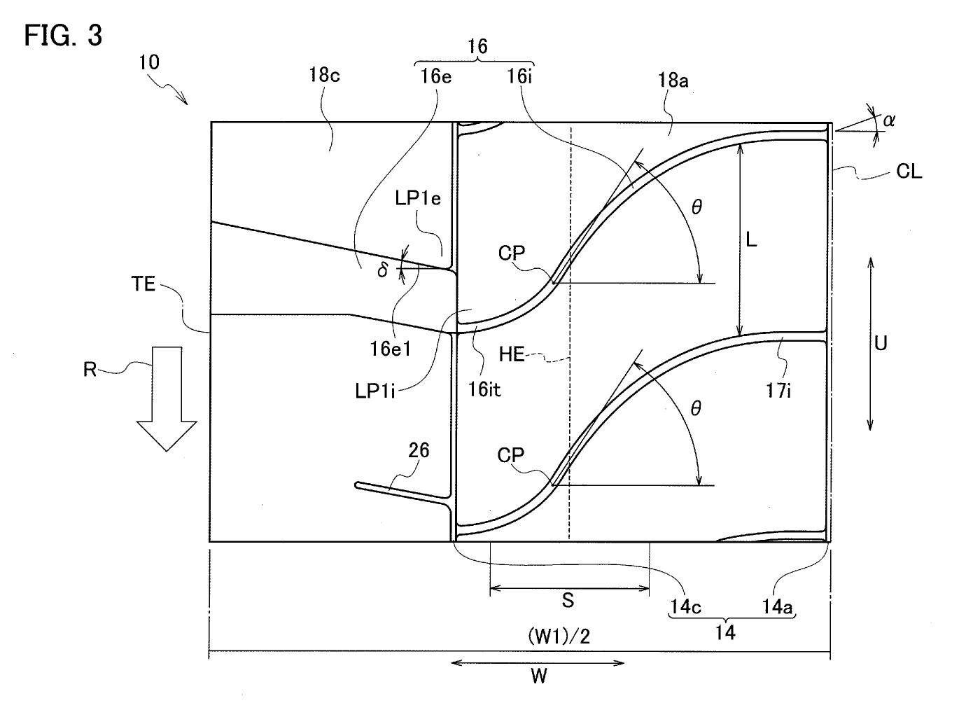

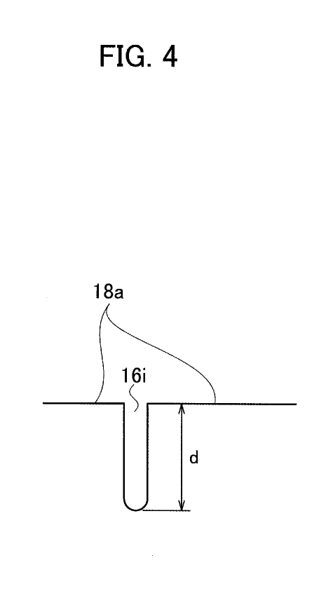

FIG. 1 is a sectional view of a construction vehicle tire of the first embodiment in a tire widthwise direction along a tire radial direction. FIG. 2 is an explanatory drawing for explaining the belt structure of the construction vehicle tire of the first embodiment. FIG. 3 is a plan view for explaining a tread pattern in the construction vehicle tire of the first embodiment. In FIG. 3, it is to be noted that separation of the upper side and the lower side of the paper plane is drawn not with break lines but with straight lines for the sake of drawing. FIG. 4 is a sectional view of a first inner widthwise groove formed at a tread portion of the construction vehicle tire of the first embodiment.

As illustrated in FIG. 1, a construction vehicle tire 1 according to the first embodiment is provided with a plurality of belt layers. Specifically, as illustrated in FIGS. 1 and 2, the construction vehicle tire 1 according to the first embodiment is provided with a protective belt layer 11 composed of two protective belts 11A/11B, a main crossing belt layer 12 composed of two main crossing belts 12A/12B, and a small crossing belt layer 13 composed of two small crossing belts 13A/13B in a tread portion 10.

In such a construction vehicle tire 1, the main crossing belt layer 12 is arranged on an outer side in the tire radial direction than the small crossing belt layer 13, and the protective belt layer 11 is arranged on an outer side in the tire radial direction than the main crossing belt layer 12 as illustrated in FIGS. 1 and 2.

In the first embodiment, the angle β (see FIG. 2) formed by a tire circumferential direction U and a cord C constituting the small crossing belt layer 13 is within the range of 4 to 10°. Accordingly, the small crossing belt layer 13 is constituted of a high angle belt having an angle equal to or smaller than 10° between the tire circumferential direction and a cord constituting the belt layer. The angle formed by a cord constituting the main crossing belt layer 12 and the tire circumferential direction U is within the range of 18 to 35°. The angle formed by a cord constituting the protective belt layer 11 and the tire circumferential direction U is within the range of 22 to 33°.

Moreover, as illustrated in FIG. 3, the construction vehicle tire 1 according to the first embodiment is provided with a plurality of block rows defined by a circumferential groove 14 extending in the tire circumferential direction U or a tread end TE (definition of the tread end will be described later), which is an end portion in a tire widthwise direction W of the tread portion 10, and a widthwise groove 16, which extends in the tire widthwise direction W, in the tread portion 10. Here, the circumferential groove 14 extends along the tire circumferential direction and is composed of a circumferential groove 14a located on a tire equator line CL, a circumferential groove 14b located between a center land portion 18a and a second land portion 18b, and a circumferential groove 14c located between the second land portion 18b and a shoulder land portion 18c.

Moreover, the construction vehicle tire 1 according to the first embodiment is constructed in a manner such that a length W2 of the widthwise groove 16 in the tire widthwise direction W becomes equal to or larger than 30% of a tread width W1 (see the definition of the tread width described later), which is the length of the tread portion 10 in the tire widthwise direction W, as illustrated in FIG. 1.

Moreover, in the first embodiment, the widthwise groove 16 is composed of: a first inner widthwise groove 16i, which opens to the circumferential groove 14a, extends outward in the tire widthwise direction, traverses the center land portion 18a, and opens to the circumferential groove 14c; and a first outer widthwise groove 16e, which opens to the circumferential groove 14c, traverses the shoulder land portion 18c, and traverses the tread end TE. The groove width of the first outer widthwise groove 16e is larger than that of the first inner widthwise groove 16i.

Moreover, the first inner widthwise groove 16i extends in a curved shape and does not have any corner portion.

Moreover, the first inner widthwise groove 16i is inclined with respect to the tire widthwise direction W so that an outer position in the tire widthwise direction of an area from the tire equator line CL to a high angle belt end HE (which is an end of a belt of the small crossing belt layer 13, that is, an end of a high angle belt in the first embodiment) is grounded earlier during tire normal rotation.

Moreover, the first inner widthwise groove 16i has an inflection point CP where the direction of a convex or a concave with respect to the tire circumferential direction U changes on at least one side of the tire equator line CL.

An area from the inflection point CP to the tire equator line CL in the first inner widthwise groove 16i extends with an angle against the tire widthwise direction W becoming smaller toward the tire equator line and opens to the circumferential groove 14a. An area from the inflection point CP to the circumferential groove 14c in the first inner widthwise groove 16i has a curved convex shape toward a side opposite to a tire normal rotation direction R, and the first inner widthwise groove 16i extends from the inflection point CP toward the tire normal rotation direction R side and outward in the tire widthwise direction with an inclination angle against the tire circumferential direction U gradually increasing to 90° and is connected with an end portion of the first outer widthwise groove 16e on the side of the circumferential groove 14c.

In addition, the first inner widthwise groove 16i and the first outer widthwise groove 16e are connected with each other so that groove wall positions on the tire normal rotation direction R side are aligned. Accordingly, the first inner widthwise groove 16i has a bent groove portion 16it forming an inner land part LP1i, which has a curved convex shape toward the tire normal rotation direction R side, in the center land portion 18a.

In the first embodiment, the angle δ formed by the tire widthwise direction W and a groove wall 16e1 on a side opposite to the tire normal rotation direction is within the range of 0°<δ≤30° at the opening position of the first outer widthwise groove 16e and the circumferential groove 14c. With such a structure, the first outer widthwise groove 16e forms an outer land part LP1e, which has a convex shape toward the tire normal rotation direction R side, in the shoulder land portion 18c. Here, the angle formed by the tire widthwise direction W and the groove wall 16e1 of the outer land part LP1e becomes the above-mentioned δ, and falls within the range of 0°<δ≤30°.

It is to be noted that a groove wall forming the first outer widthwise groove 16e on the tire normal rotation direction R side, that is, a groove wall opposed to the groove wall 16e1 extends outward in the tire widthwise direction while being inclined toward a side opposite to the tire normal rotation direction R and extends along the tire widthwise direction W in the middle, so that the first outer widthwise groove 16e extends with the groove width becoming larger toward the outer side in the tire widthwise direction from the middle and opens to the tread end TE.

Moreover, in the shoulder land portion 18c, a second outer widthwise groove 26 is formed at a position spaced from the first outer widthwise groove 16e at a predetermined interval in the tire circumferential direction U. The groove width of the second outer widthwise groove 26 is smaller than that of the first outer widthwise groove 16e.

The second outer widthwise groove 26 opens to the circumferential groove 14c, linearly extends toward a side opposite to the tire normal rotation direction R side and outward in the tire widthwise direction, and further terminates in the shoulder land portion 18c.

Moreover, between first inner widthwise grooves 16i adjacent to each other in the tire circumferential direction U, a second inner widthwise groove 17i, which has the same shape as the first inner widthwise groove 16i, opens to the circumferential groove 14c, and reaches the tire equator line CL, is arranged.

The opening position of the second outer widthwise groove 26 to the circumferential groove 14c is a position shifted toward opposite side of the tire normal rotation direction R from the opening position of the second inner widthwise groove 17i to the circumferential groove 14c.

Moreover, in a belt layer B arranged on an inner side in the tire radial direction than the tread portion 10, the small crossing belt layer 13 composed of the two small crossing belts 13A/13B as described above is arranged as a high angle belt.

In addition, in tread surface view, that is, in plan view of the tread portion 10, a inflection point CP is arranged in a tire widthwise area S within ⅛, or more preferably a tire widthwise area within 1/16, of the tread width W1 from the high angle belt end HE as the widthwise center.

Here, the tread width is the “tread width” defined by JATMA YEAR BOOK. Moreover, the above-described tread end means the outermost position in the tire widthwise direction of the tire tread surface, which is a surface where the tire surface comes into contact with the ground in a state where the tire is assembled to a normal rim and filled to have normal internal pressure, and a normal load is applied. It is to be noted that “normal rim” means a standard rim specified in the following standard according to the size of the tire, “normal internal pressure” means a pneumatic pressure corresponding to the maximum load capacity of a single wheel in an applicable size described in the following standard, and “normal load” means the maximum load of a single wheel in an applicable size of the following standard, that is, the maximum load capacity. In addition, the standard is an industrial standard effective in an area where the tire is produced or used, for example “JATMA YEAR BOOK” from “Japan Automobile Tyre Manufacturers Association” in Japan, “YEAR BOOK” from “THE TIRE AND RIM ASSOCIATION INC.” in the United States, or “STANDARD MANUAL” from “The European Tyre and Rim Technical Organisation” in Europe.

In addition, in the first embodiment, the maximum value of the angle θ formed by the tire widthwise direction W and the first inner widthwise groove 16i is set within the range of 20 to 80°. It is to be noted that FIG. 3 illustrates a state where the angle θ becomes largest at the inflection point CP.

Furthermore, in the first embodiment, the angle α formed by the first inner widthwise groove 16i and the tire widthwise direction W is within the range of 0 to 20° at the intersection position of the tire equator line CL and the first inner widthwise groove 16i. It is to be noted that FIG. 3 illustrates the first inner widthwise groove 16i in a manner such that a becomes approximately 0°.

Moreover, the distance L (see FIG. 3) between the first inner widthwise groove 16i and the second inner widthwise groove 17i adjacent to each other in the tire circumferential direction U, and the groove depth d (see FIG. 4) of the first inner widthwise groove 16i along the tire radial direction in the first embodiment satisfy the following relational expression.

d/L> 1/10

When focusing on wear resistance property, it is to be noted that the width of the circumferential groove 14 in the tire widthwise direction W is preferably equal to or smaller than 10 mm with which the land portions support each other when force is applied.

On the other hand, when focusing on heat dissipation property, the width of the circumferential groove 14 in the tire widthwise direction W is preferably larger than 10 mm.

Furthermore, the construction vehicle tire 1 according to the first embodiment may be constructed in a manner such that the circumferential pitch of the first inner widthwise grooves 16i becomes equal to or larger than 50 mm.

(Function, Effect)

The following description will explain the functions and effects of the first embodiment.

In the construction vehicle tire 1 of the first embodiment, the first inner widthwise groove 16i configuring the widthwise groove 16 opens to the circumferential groove 14a and has an inflection point CP where the direction of a convex or concave with respect to the tire circumferential direction U changes toward the outer side in the tire widthwise direction.

In addition, an inner side of the first inner widthwise groove 16i in the tire widthwise direction than the inflection point CP extends with the angle θ against the tire widthwise direction W becoming smaller toward the tire equator line and reaches the tire equator line.

In addition, an outer side of the first inner widthwise groove 16i in the tire widthwise direction than the inflection point CP extends from the inflection point CP toward the tire normal rotation direction R side and outward in the tire widthwise direction, so that an inner land part LP1i having a curved convex shape toward the tire normal rotation direction R side is formed. In addition, in tread surface view, the inflection point CP is arranged in a tire widthwise area within ⅛ of the tread width W1 from the high angle belt end HE as the widthwise center.

In addition, the first outer widthwise groove 16e configuring the widthwise groove 16 extends toward a side opposite to the tire normal rotation direction R side and outward in the tire widthwise direction, so that an outer land part LP1e having a convex shape toward the tire normal rotation direction R side is formed in the shoulder land portion 18c.

Therefore, when the tire is rotated, the tire rubber is caused to flow in the tire normal rotation direction R by incompressibility of the tire rubber, and circumferential driving force is generated in the vicinity of the apex portion of the pattern, that is, in the vicinity of the apex portion of the outer land part LP1e or the inner land part LP1i having a curved convex shape toward the tire normal rotation direction R side and acts as force to cancel the braking force generated due to the tire structure. Furthermore, since the widthwise groove 16 has a curved shape reaching from the inflection point CP to the equator line CL, uniform wear resistance performance in the tire widthwise direction can be obtained on an outer side in the tire widthwise direction than the inflection point CP in comparison with a case where the widthwise groove 16 on an inner side in the tire widthwise direction than the inflection point CP has a groove shape inclined at a certain angle. Accordingly, uneven wear caused by the shearing force due to the driving force and the braking force is suppressed, and therefore the construction vehicle tire 1 with improved uneven wear resistance property can be obtained.

It is to be noted that FIG. 3 illustrates an example in which the position in the tire widthwise direction of the inflection point CP is arranged on a slightly outer side in the tire widthwise direction than the high angle belt end HE, and a remarkable effect in suppressing uneven wear at the ¼ point is achieved.

Moreover, by forming the widthwise groove 16 to have a curved shape as in the first embodiment, it becomes possible to incline only a site, which is desired to be inclined, of the widthwise groove 16 with respect to the tire circumferential direction U, and it becomes easy to ensure the rigidity in the tire widthwise direction. Moreover, since the inclination of the widthwise groove 16 can be made large in comparison with a case where the widthwise groove 16 has a corner portion, the above-described circumferential driving force can be made large effectively.

Moreover, since an area on an inner side in the tire widthwise direction than the inflection point CP extends with the angle θ against the tire widthwise direction W becoming smaller toward the tire equator line and reaches the tire equator line as described above, the first inner widthwise groove 16i is inclined with respect to the tire widthwise direction so that an outer position in the tire widthwise direction of an area from the tire equator line CL to the high angle belt end HE is grounded earlier during rotation in the tire normal rotation direction R. Therefore, the above-described circumferential driving force can be made large further effectively.

Moreover, the maximum value of the angle θ formed by the tire widthwise direction W and the first inner widthwise groove 16i is within the range of 20 to 80°. Therefore, the above-described circumferential driving force can be made large effectively.

Moreover, the angle α formed by the first inner widthwise groove 16i and the tire widthwise direction W is within the range of 0 to 20° at an intersection position of the tire equator line CL and the first inner widthwise groove 16i. This effectively prevents the block rigidity from being impaired.

Moreover, in the first embodiment, the groove wall 16e1 forming the first outer widthwise groove 16e on a side opposite to the tire normal rotation direction R side extends outward in the tire widthwise direction while being inclined toward the tire normal rotation direction R side. In addition, the angle δ formed by the groove wall 16e1 and the tire widthwise direction W, that is, the angle δ formed by the outer land part LP1e and the tire widthwise direction is within the range of 0°<δ≤30° at the opening position of the first outer widthwise groove 16e and the circumferential groove 14c. It is therefore possible to further improve the uneven wear resistance property while effectively preventing the block rigidity of the outer land part LP1e from being impaired.

Although the first embodiment explains a case where the inflection point CP is arranged in a tire widthwise area within ⅛ of the tread width W1 in tread surface view from the high angle belt end HE as the widthwise center as an example in which the inflection point CP is arranged within a predetermined area in the tire widthwise direction, it is to be noted that the uneven wear resistance property at the tread rubber part can be improved according to a similar principle even when the connection portion FP is arranged in a tire widthwise area S within ⅛, or more preferably 1/16, of the tread width W1 not from the high angle belt end HE but from a position in the tire widthwise direction where the rolling radius is large during tire normal rotation as the widthwise center. Furthermore, a similar effect can be achieved even in a construction vehicle tire that does not have a high angle belt.

### Test Example 1

In order to confirm the effect of the present invention, all of prototype tires of Examples 1 to 5 to which the present invention was applied were made at size 59/80R63, and comparison was made regarding uneven wear resistance property. The tires of Examples 1 to 5 were tires having the structure described in the first embodiment, the angle formed by the widthwise groove and the tire widthwise direction at the intersection position of the tire equator line and the widthwise groove was set constant at 10°, the position of the inflection point was set to be constant in the tire widthwise direction, and the maximum value θ of the angle formed by the inner widthwise groove and the tire widthwise direction was respectively set to 15°, 20°, 50°, 80°, and 85°.

In the uneven wear resistance property test, each of the above tires was mounted on a normal rim and filled to have normal internal pressure. Then, each tire was attached to an indoor drum testing machine, loaded with a normal load, and run for 24 hours at a speed of 8 km/h. Then, the amount of uneven wear at the ¼ point of the tread portion of the tire after running was measured

to judge the uneven wear resistance performance. A case where obvious uneven wear was not observed was judged as “good”, while a case where sight uneven wear was observed was judged as “acceptable”.

TABLE 1

| | Example 1 | Example 2 | Example 3 | Example 4 | Example 5 |
|---|---|---|---|---|---|
| MAXIMUM VALUE OF | 15 | 20 | 50 | 80 | 85 |
| ANGLE θ [°] FORMED | | | | | |
| BY INNER WIDTHWISE | | | | | |
| GROOVE AND TIRE | | | | | |
| WIDTHWISE | | | | | |
| DIRECTION | | | | | |
| UNEVEN WEAR | ACCEPTABLE | GOOD | GOOD | GOOD | ACCEPTABLE |
| RESISTANCE | | | | | |

The test results are as illustrated in Table 1. That is, in this test, it was confirmed that the uneven wear resistance performance in Examples 2 to 4 in which the angle θ was set to 20°, 50°, and 80° was better than that of Examples 1 and 5 in which the angle θ was set to 15° and 85°.

### Test Example 2

In order to confirm the effect of the present invention, all of prototype tires of the examples to which the present invention was applied were made at size 59/80R63, and comparison was made regarding block rigidity and uneven wear resistance property. The tires of Examples 6 to 9 were tires having the structure described in the first embodiment, the maximum value of the angle θ formed by the inner widthwise groove and the tire widthwise direction was set constant at 50°, the position of the inflection point was set to be constant in the tire widthwise direction, and the angle α formed by the widthwise groove and the tire widthwise direction at the intersection position of the tire equator line and the widthwise groove was respectively set to 0°, 10°, 20°, and 25°.

In the block rigidity test, the base of the block was fixed, constant shearing force (the direction was the tire circumferential direction) was applied to the tread surface of the block, and the displacement amount of the tread surface of the block was measured. The test was carried out on the tires of Examples 6 to 9. Evaluation is shown using indexes with respect to the reciprocal of the displacement amount of Example 6 with the angle α set at 0° shown as 100, and a larger numerical value indicates that the displacement amount is smaller and the block rigidity is higher. Regarding uneven wear resistance property, an uneven wear resistance property test similar to Example 1 was carried out on the tires of Examples 6 to 9 and evaluation was made.

TABLE 2

| | Example 6 | Example 7 | Example 8 | Example 9 |
|---|---|---|---|---|
| MAXIMUM | 0 | 10 | 20 | 25 |
| VALUE OF | | | | |
| ANGLE θ [°] | | | | |
| FORMED | | | | |
| BY INNER | | | | |
| WIDTHWISE | | | | |
| GROOVE | | | | |
| AND TIRE | | | | |
| WIDTHWISE | | | | |
| DIRECTION | | | | |
| BLOCK | 100 | 99 | 99 | 96 |
| RIGIDITY | | | | |
| UNEVEN WEAR | GOOD | GOOD | GOOD | ACCEPTABLE |
| RESISTANCE | | | | |

The test results are as described in Table 2. That is, in Example 9 in which the angle α was set to 25°, the index of block rigidity lowered to 96, and accordingly, the uneven wear resistance property lowered in comparison with Examples 7 and 8 in which the evaluation index of block rigidity was 99. On the other hand, in Examples 7 and 8 in which the value of the evaluation index of block rigidity was 99, no lowering in the uneven wear resistance property in comparison with Example 6 was confirmed.

### Second Embodiment

Next, the second embodiment will be described. The second embodiment is different from the first embodiment in that a tire normal rotation direction R is in the opposite direction. Therefore, in the second embodiment, parts similar to those of the first embodiment are denoted by the same reference numerals, the detailed explanation thereof is omitted, and operations, effects and the like to be obtained by making the tire normal rotation direction R opposite to that of the first embodiment will be described in detail.

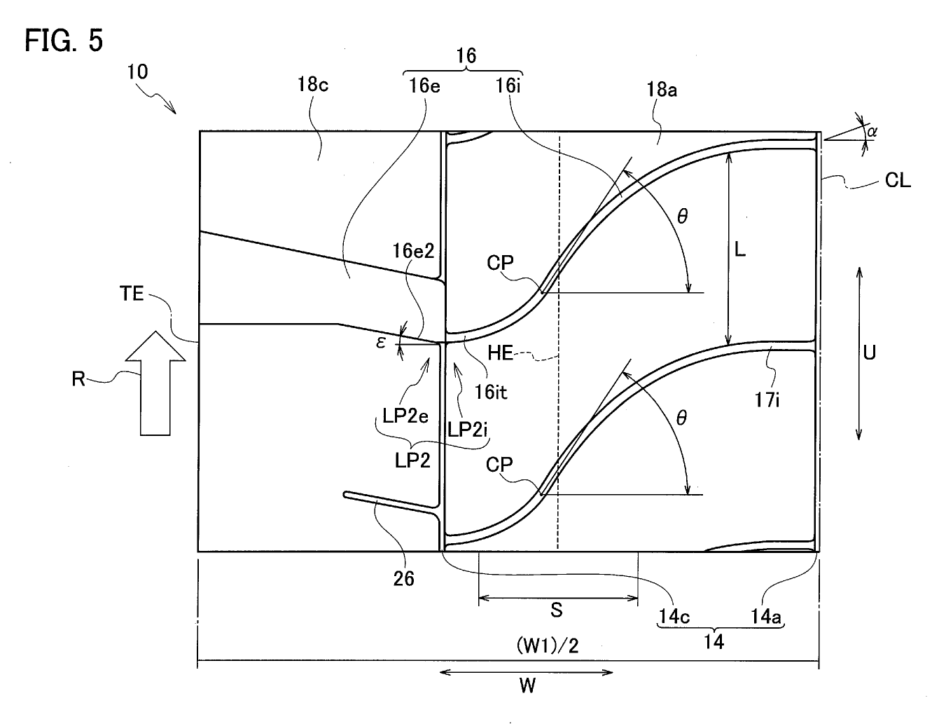

FIG. 5 is a plan view for explaining a tread pattern in a construction vehicle tire of the second embodiment. In the second embodiment, an area from an inflection point CP to a tire equator line CL in a first inner widthwise groove 16i extends with an angle against a tire widthwise direction W becoming smaller toward the tire equator line and opens to a circumferential groove 14a. An area from the inflection point CP to a circumferential groove 14c in the first inner widthwise groove 16i has a curved convex shape toward a tire normal rotation direction R side, and the first inner widthwise groove 16i extends from the inflection point CP toward a side opposite to the tire normal rotation direction R and outward in the tire widthwise direction with an inclination angle against a tire circumferential direction U gradually increasing to 90° and is connected with an end portion of a first outer widthwise groove 16e on the side of the circumferential groove 14c.

In addition, the first inner widthwise groove 16i and the first outer widthwise groove 16e are connected with each other so that groove wall positions on a side opposite to the tire normal rotation direction R side, that is, the positions in the tire circumferential direction of groove walls opposed to the groove walls on the tire normal rotation direction R side are aligned. Accordingly, the first inner widthwise groove 16i has a bent groove portion 16it forming the inner land part LP2i, which has a curved concave shape with respect to the tire normal rotation direction R.

A groove wall 16e2 forming the first outer widthwise groove 16e on a side opposite to the tire normal rotation direction R side, that is, a groove wall opposed to the groove wall on the tire normal rotation direction R side extends outward in the tire widthwise direction while being inclined toward the tire normal rotation direction R side. In the second embodiment, the angle ε formed by the groove wall 16e2 and the tire widthwise direction W is within the range of 0°<ε≤30° at the opening position of the first outer widthwise groove 16e and the circumferential groove 14c. As described above, the first outer widthwise groove 16e configuring a widthwise groove 16 extends toward the tire normal rotation direction R side and outward in the tire widthwise direction, so that an outer land part LP2e, which forms a land portion having a concave shape with respect to the tire normal rotation direction R together with an adjacent center land portion 18a on an inner side in the tire widthwise direction, is formed.

Moreover, in the second embodiment, the groove wall 16e2 on a side opposite to the tire normal rotation direction R side extends along the tire widthwise direction W in the middle, so that the first outer widthwise groove 16e extends with the groove width becoming larger toward the outer side in the tire widthwise direction from the middle and opens to a tread end TE.

Moreover, in a shoulder land portion 18c, a second outer widthwise groove 26 is formed at a position spaced from the first outer widthwise groove 16e at a predetermined interval in the tire circumferential direction U. The groove width of the second outer widthwise groove 26 is smaller than that of the first outer widthwise groove 16e.

The second outer widthwise groove 26 opens to the circumferential groove 14c, linearly extends toward the tire normal rotation direction R side and outward in the tire widthwise direction, and further terminates in the shoulder land portion 18c.

Moreover, between first inner widthwise grooves 16i adjacent to each other in the tire circumferential direction U, a second inner widthwise groove 17i, which has the same shape as the first inner widthwise groove 16i, opens to the circumferential groove 14c, and reaches the tire equator line CL, is arranged.

The opening position of the second outer widthwise groove 26 to the circumferential groove 14c is a position shifted toward the tire normal rotation direction R side from the opening position of the second inner widthwise groove 17i to the circumferential groove 14c.

Moreover, in a belt layer B arranged on an inner side in a tire radial direction than a tread portion 10, a small crossing belt layer 13 composed of two small crossing belts 13A/13B as described above is arranged as a high angle belt. In addition, in tread surface view, that is, in plan view of the tread portion 10, an inflection point CP is arranged in a tire widthwise area S within ⅛, or more preferably a tire widthwise area within 1/16, of a tread width W1 from the high angle belt end HE as the widthwise center.

In addition, in the second embodiment, the maximum value of the angle θ formed by the tire widthwise direction W and the first inner widthwise groove 16i is set within the range of 20 to 80°. It is to be noted that FIG. 5 illustrates a state where the angle θ becomes largest at the inflection point CP.

Furthermore, in the second embodiment, the angle α formed by the first inner widthwise groove 16i and the tire widthwise direction W is within the range of 0 to 20° at the intersection position of the tire equator line and the first inner widthwise groove 16i. It is to be noted that FIG. 3 illustrates the first inner widthwise groove 16i in a manner such that a becomes approximately 0°.

Moreover, in the second embodiment, the distance L (see FIG. 3) between the first inner widthwise groove 16i and the second inner widthwise groove 17i adjacent to each other in the tire circumferential direction U, and the groove depth d (see FIG. 4) of the first inner widthwise groove 16i along the tire radial direction satisfy the following relational expression.

d/L> 1/10

When focusing on wear resistance property, it is to be noted that the width of the circumferential groove 14 in the tire widthwise direction W is preferably equal to or smaller than 10 mm with which the land portions support each other when force is applied.

On the other hand, when focusing on heat dissipation property, the width of the circumferential groove 14 in the tire widthwise direction W is preferably larger than 10 mm.

Furthermore, the construction vehicle tire 1 according to the second embodiment may be constructed in a manner such that the circumferential pitch of the first inner widthwise grooves 16i becomes equal to or larger than 50 mm.

(Function, Effect)

The following description will explain the functions and effects of the second embodiment.

In the construction vehicle tire 1 of the second embodiment, the first inner widthwise groove 16i configuring the widthwise groove 16 opens to the circumferential groove 14a and has an inflection point CP where the direction of a convex or concave with respect to the tire circumferential direction U changes toward the outer side in the tire widthwise direction.

In addition, an inner side of the first inner widthwise groove 16i in the tire widthwise direction than the inflection point CP extends with the angle θ against the tire widthwise direction W becoming smaller toward the tire equator line and reaches the tire equator line. Here, as the angle θ becomes larger, the shearing rigidity of the tire tread surface lowers, and therefore the wear resistance performance deteriorates especially during acceleration or deceleration and during turning. Since the angle θ is larger at a position closer to the inflection point CP, a great effect can be obtained in a viewpoint of maintaining the shearing rigidity of the entire tire while maximizing the braking force at a curved concave land part located on the tire normal rotation side of the bent groove portion 16it by making the angle θ large in the vicinity of the inflection point CP and small in the vicinity of the equator.

In addition, an outer side of the first inner widthwise groove 16i in the tire widthwise direction than the inflection point CP extends from the inflection point CP toward a side opposite to the tire normal rotation direction R side and outward in the tire widthwise direction, so that an inner land part LP2i having a curved convex shape toward a side opposite to the tire normal rotation direction R side, that is, a curved concave shape with respect to the tire normal rotation direction R is formed. In addition, in tread surface view, the inflection point CP is arranged in a tire widthwise area within ⅛ of the tread width W1 from the high angle belt end HE as the widthwise center.

In addition, the first outer widthwise groove 16e configuring the widthwise groove 16 extends toward the tire normal rotation direction R side and outward in the tire widthwise direction, so that the outer land part LP2e, which forms a land portion having a concave shape with respect to the tire normal rotation direction R together with an adjacent center land portion 18a on an inner side in the tire widthwise direction, is formed.

Therefore, when the tire is rotated in the tire normal rotation direction R during acceleration or the like, force in the tire normal rotation direction R, that is, driving force is generated at the tread rubber part in the vicinity of the high angle belt end HE where the rolling radius is large during tire normal rotation, while the tire rubber is caused to flow in a direction opposite to the tire normal rotation direction R by incompressibility of the tire rubber, and circumferential braking force is generated in a land part LP2 (land part composed of the inner land part LP2i and the outer land part LP2e) having a curved concave shape with respect to the tire normal rotation direction R. As a result, this functions as force to suppress the shearing force to be generated against the tread rubber part in the vicinity of the high angle belt end HE where the rolling radius is large during tire normal rotation, that is, to cancel the shearing force when the forces are equal. Accordingly, uneven wear caused by the shearing force due to the driving force and the braking force is suppressed, and therefore the construction vehicle tire with improved uneven wear resistance property can be obtained.

It is to be noted that FIG. 5 illustrates an example in which the position in the tire widthwise direction of the inflection point CP is arranged on a slightly outer side in the tire widthwise direction than the high angle belt end HE, and a remarkable effect in suppressing uneven wear at the ¼ point is achieved.

Moreover, by forming the first inner widthwise groove 16i to have a curved shape as in the second embodiment, it becomes possible to incline only a site, which is desired to be inclined, of the first inner widthwise groove 16i with respect to the tire circumferential direction U, and it becomes easy to ensure the rigidity in the tire widthwise direction. Moreover, since the inclination of the first inner widthwise groove 16i can be made large in comparison with a case where the first inner widthwise groove 16i has a corner portion, the above-described circumferential breaking force can be made large effectively.

Moreover, since an area on an inner side in the tire widthwise direction than the inflection point CP extends with the angle θ against the tire widthwise direction W becoming smaller toward the tire equator line and reaches the tire equator line as described above, the first inner widthwise groove 16i is inclined with respect to the tire widthwise direction so that an inner position in the tire widthwise direction of an area from the tire equator line CL to the high angle belt end HE is grounded earlier during rotation in the tire normal rotation direction R. Therefore, the above-described circumferential braking force can be made large further effectively.

Moreover, the maximum value of the angle θ formed by the tire widthwise direction W and the first inner widthwise groove 16i is within the range of 20 to 80°. Therefore, the above-described circumferential braking force can be made large effectively.

Moreover, the second embodiment is constructed in a manner such that a length W2 of the widthwise groove 16 in the tire widthwise direction W becomes equal to or larger than 30% of a length W1 of the tread portion 10 in the tire widthwise direction W. Therefore, by effectively making the above-mentioned circumferential braking force large, it becomes possible to significantly improve the uneven wear resistance property.

Moreover, the angle α formed by the first inner widthwise groove 16i and the tire widthwise direction W is within the range of 0 to 20° at an intersection position of the tire equator line CL and the first inner widthwise groove 16i. This effectively prevents the block rigidity from being impaired.

Moreover, in the second embodiment, the angle ε formed by the groove wall 16e2 and the tire widthwise direction W is within the range of 0°<ε≤30° at the opening position of the first outer widthwise groove 16e and the circumferential groove 14c. It is therefore possible to further improve the uneven wear resistance property while effectively preventing the block rigidity from being impaired.

Although the second embodiment explains a case where the inflection point CP is arranged in a tire widthwise area within ⅛ of the tread width W1 in tread surface view from the high angle belt end HE as the widthwise center as an example in which the inflection point CP is arranged within a predetermined area in the tire widthwise direction, it is to be noted that the uneven wear resistance property at the tread rubber part can be improved according to a similar principle even when the inflection point CP is arranged in a tire widthwise area within ⅛, or more preferably 1/16, of the tread width W1 not from the high angle belt end HE but from a position in the tire widthwise direction where the rolling radius is large during tire normal rotation as the widthwise center. Furthermore, even a construction vehicle tire not having a high angle belt can achieve a similar effect, and a similar effect can also be achieved with not a construction vehicle tire but a heavy load tire.

This application claims priority based on Japanese Patent Application No. 2016-106225 filed on May 27, 2016, and the entire contents thereof are herein incorporated by reference.

### INDUSTRIAL APPLICABILITY

The heavy load tire according to the embodiments of the present invention improves uneven wear resistance property by suppressing shearing force to be generated between a tread rubber part where driving force is generated and a tread rubber part adjacent to the above-described tread rubber part where braking force is generated.

### REFERENCE SIGNS LIST

1 CONSTRUCTION VEHICLE TIRE
10 TREAD PORTION
13 SMALL CROSSING BELT LAYER (HIGH ANGLE BELT)
14 CIRCUMFERENTIAL GROOVE
14a CIRCUMFERENTIAL GROOVE
14b CIRCUMFERENTIAL GROOVE
14c CIRCUMFERENTIAL GROOVE
16 WIDTHWISE GROOVE
16e FIRST OUTER WIDTHWISE GROOVE
16i FIRST INNER WIDTHWISE GROOVE
16e1 GROOVE WALL
16e2 GROOVE WALL
17i SECOND INNER WIDTHWISE GROOVE
26 SECOND OUTER WIDTHWISE GROOVE
B BELT LAYER
CL TIRE EQUATOR LINE
CP INFLECTION POINT
HE HIGH ANGLE BELT END
TE TREAD END
R TIRE NORMAL ROTATION DIRECTION
U TIRE CIRCUMFERENTIAL DIRECTION
W TIRE WIDTHWISE DIRECTION
W1 TREAD WIDTH
θ ANGLE

1. A heavy load tire comprising a tread portion, wherein
the tread portion is partitioned into a plurality of portions by a widthwise groove extending in a tire widthwise direction, and at least one of a circumferential groove extending in a tire circumferential direction and a tread end that is an end portion of the tread portion,
the circumferential groove and the widthwise groove are formed on at least one side of a tire equator line,
the widthwise groove is composed of a first inner widthwise groove, which opens to the circumferential groove, extends inward in the tire widthwise direction, and reaches the tire equator line, and a first outer widthwise groove, which is wider than the first inner widthwise groove, opens to the circumferential groove at a position opposed to the first inner widthwise groove, and extends outward in the tire widthwise direction, and are arrayed in the tire circumferential direction,
the first inner widthwise groove has an inflection point where a direction of a convex or a concave with respect to the tire circumferential direction changes, extends from the inflection point to the tire equator line with an angle against the tire widthwise direction becoming smaller toward the tire equator line, and has a curved convex shape toward a tire normal rotation direction side from the inflection point to the circumferential groove, and
a groove wall forming the first outer widthwise groove on a side opposite to a tire normal rotation direction extends outward in the tire widthwise direction while being inclined toward a side opposite to the tire normal rotation direction.

2. The heavy load tire according to claim 1, wherein the inflection point is arranged within a predetermined area in the tire widthwise direction.

3. The heavy load tire according to claim 2, wherein
a high angle belt is arranged in a belt layer arranged on an inner side in a tire radial direction than the tread portion, and
the inflection point is arranged in a tire widthwise area within ⅛ of a tread width from a high angle belt end as a widthwise center in tread surface view.

4. The heavy load tire according to claim 1, wherein a maximum value of an angle θ formed by the widthwise groove and the tire widthwise direction is within a range of 20 to 80°.

5. The heavy load tire according to claim 1, wherein a second outer widthwise groove, which is narrower than the first outer widthwise groove, opens to the circumferential groove, and extends outward in the tire widthwise direction, is arranged between the first outer widthwise grooves adjacent to each other in the tire circumferential direction.

6. The heavy load tire according to claim 5, wherein
a second inner widthwise groove, which has a same shape as the first inner widthwise groove, opens to the circumferential groove, and reaches the tire equator line, is arranged between the first inner widthwise grooves adjacent to each other in the tire circumferential direction, and
an opening position of the second outer widthwise groove to the circumferential groove is set to a position shifted in the tire circumferential direction from an opening position of the second inner widthwise groove to the circumferential groove.

7. A heavy load tire comprising a tread portion, wherein
the tread portion is partitioned into a plurality of portions by a widthwise groove extending in a tire widthwise direction, and at least one of a circumferential groove extending in a tire circumferential direction and a tread end that is an end portion of the tread portion,
the circumferential groove and the widthwise groove are formed on at least one side of a tire equator line,
the widthwise groove is composed of a first inner widthwise groove, which opens to the circumferential groove, extends inward in the tire widthwise direction, and reaches the tire equator line, and a first outer widthwise groove, which is wider than the first inner widthwise groove, opens to the circumferential groove at a position opposed to the first inner widthwise groove, and extends outward in the tire widthwise direction, and are arrayed in the tire circumferential direction,
the first inner widthwise groove has an inflection point where a direction of a convex or a concave with respect to the tire circumferential direction changes, extends from the inflection point to the tire equator line with an angle against the tire widthwise direction becoming smaller toward the tire equator line, and has a curved convex shape toward a side opposite to the tire normal rotation direction from the inflection point to the circumferential groove, and
a groove wall forming the first outer widthwise groove on a side opposite to the tire normal rotation direction extends outward in the tire widthwise direction while being inclined toward the tire normal rotation direction side.

8. The heavy load tire according to claim 7, wherein the inflection point is arranged within a predetermined area in the tire widthwise direction.

9. The heavy load tire according to claim 8, wherein
a high angle belt is arranged in a belt layer arranged on an inner side in a tire radial direction than the tread portion, and
the inflection point is arranged in a tire widthwise area within ⅛ of a tread width from a high angle belt end as a widthwise center in tread surface view.

10. The heavy load tire according to claim 7, wherein a maximum value of an angle θ formed by the widthwise groove and the tire widthwise direction is within a range of 20 to 80°.

11. The heavy load tire according to claim 7, wherein a second outer widthwise groove, which is narrower than the first outer widthwise groove, opens to the circumferential groove, and extends outward in the tire widthwise direction, is arranged between the first outer widthwise grooves adjacent to each other in the tire circumferential direction.

12. The heavy load tire according to claim 11, wherein
a second inner widthwise groove, which has a same shape as the first inner widthwise groove, opens to the circumferential groove, and reaches the tire equator line, is arranged between the first inner widthwise grooves adjacent to each other in the tire circumferential direction, and
an opening position of the second outer widthwise groove to the circumferential groove is set to a position shifted in the tire circumferential direction from an opening position of the second inner widthwise groove to the circumferential groove.
